(19) United States
(12) Patent Application Publication
(10) Pub. No.: US 2016/0266780 A1
(43) Pub. Date: Sep. 15, 2016

(54) ELECTRONIC DEVICES, METHODS FOR OPERATING USER INTERFACE AND COMPUTER PROGRAM PRODUCTS

(71) Applicant: Acer Incorporated, New Taipei City (TW)

(72) Inventor: Chun-Hao WU, New Taipei City (TW)

(21) Appl. No.: 14/722,470

(22) Filed: May 27, 2015

(30) Foreign Application Priority Data
Mar. 9, 2015 (TW) 104107368

(51) Int. Cl. G06F 3/0484; G06F 3/0482; G06F 3/0487; G06F 3/0481

(52) U.S. Cl. CPC G06F 3/04847; G06F 3/04817; G06F 3/0482; G06F 3/04842; G06F 3/0487

(57) ABSTRACT

An electronic device includes an input unit, a storage unit and a processing unit. The input unit receives an input signal corresponding to a Uniform Resource Identifier of a file resource. The storage unit stores settings of a default application and a plurality of applications for executing the file resource. The processing unit executes the file resource according to the input signal and the default application. After executing the file resource by the default application, the processing unit clears the setting of the default application and displays application shortcuts corresponding to the applications in a window when a disabling signal corresponding to the default application is received within a first predetermined time and the input signal corresponding to the Uniform Resource Identifier is received within a second predetermined time. The processing unit further re-executes the file resource according to the input signal.

### CROSS REFERENCE TO RELATED APPLICATIONS

This Application claims priority of Taiwan Patent Application No. 104107368, filed on Mar. 9, 2015, the entirety of which is incorporated by reference herein.

### BACKGROUND OF THE INVENTION

1. Field of the Invention

The application relates in general to electronic devices and methods for operating user interface and computer program products, and in particular to electronic devices and methods for operating user interface and computer program products for changing the settings of the application for executing the file resource by disabling the default application within a predetermined time and then re-executing the file resource once again.

2. Description of the Related Art

These days, due to the rapid development of technology, electronic devices are widely used for executing a plurality of applications. When a user wants to execute the Uniform Resource Identifier (URI) displayed in some of the applications, such as a webpage address, the system will display a dialog for choosing one of a plurality of browsers the first time, and then sets the chosen browser as the default browser. Next time when the user executes the Uniform Resource Identifier once again, the system will go to the webpage address using the default browser without displaying the dialog.

However, when the user wants to go to a webpage address using another browser, complicated steps are needed for displaying the dialog once again, making it inconvenient for the user. Thus, how to simplify the steps for clearing the default is a problem which needs to be solved immediately.

### BRIEF SUMMARY OF INVENTION

An embodiment of the invention provides an electronic device, including an input unit, a storage unit and a processing unit. The input unit receives an input signal corresponding to a Uniform Resource Identifier of a file resource. The storage unit stores settings of a default application and a plurality of applications for executing the file resource. The processing unit executes the file resource according to the input signal and the default application. After executing the file resource using the default application, the processing unit clears the setting of the default application and displays application shortcuts corresponding to the applications in a window when a disabling signal corresponding to the default application is received within a first predetermined time and the input signal corresponding to the Uniform Resource Identifier is received within a second predetermined time. The processing unit further re-executes the file resource according to the input signal.

Another embodiment of the invention provides a method for operating a user interface, adapted to an electronic device, comprising: receiving an input signal, wherein the input signal corresponds to a Uniform Resource Identifier of a file resource; executing the file resource according to the input signal and a default application; determining whether a disabling signal corresponding to the default application is received within a first predetermined time; determining whether the input signal corresponding to the Uniform Resource Identifier is received within a second predetermined time after receiving the disabling signal within the first predetermined time; clearing a setting of the default application and displaying application shortcuts corresponding to a plurality of applications in a window after receiving the input signal within the second predetermined time; and re-executing the file resource according to the input signal corresponding to the application.

Another embodiment of the invention provides a computer program product encoded in at least one non-transitory computer usable medium for use with a computing device, wherein the computer device comprises a storage unit, configured to store settings of a default application and a plurality of applications for executing the file resource, the computer program product comprising: computer readable program code embodied in said medium, for specifying a microprocessor, the computer readable program code comprising: first program code for receiving an input signal by an electronic device, wherein the input signal corresponds to a Uniform Resource Identifier of a file resource; second program code for executing the file resource according to the input signal and a default application; third program code for determining whether a disabling signal corresponding to the default application is received within a first predetermined time; fourth program code for determining whether the input signal corresponding to the Uniform Resource Identifier is received within a second predetermined time after receiving the disabling signal within the first predetermined time; fifth program code for clearing a setting of the default application and displaying application shortcuts corresponding to a plurality of applications in a window after receiving the input signal within the second predetermined time; and sixth program code for re-executing the file resource according to the input signal corresponding to the application.

### BRIEF DESCRIPTION OF DRAWINGS

The invention can be more fully understood by reading the subsequent detailed description and examples with references made to the accompanying drawings, wherein:

FIG. 1 is a block diagram of the electronic device in accordance with an embodiment of the invention;

FIGS. 2A-2D are schematic diagrams for operating the user interface in accordance with an embodiment of the invention;

FIG. 3A-3D are schematic diagrams for operating the user interface in accordance with another embodiment of the invention;

FIG. 4A-4D are schematic diagrams for operating the user interface in accordance with another embodiment of the invention;

FIG. 5 is a flow chart of the method for operating the user interface in accordance with an embodiment of the invention.

### DETAILED DESCRIPTION OF INVENTION

Further areas in which the present devices and methods can be applied will become apparent from the following detailed description. It should be understood that the detailed description and specific examples, while indicating exemplary embodiments of the electronic devices, the methods for operating user interface and the computer program products, are intended for the purposes of illustration only and are not intended to limit the scope of the invention.

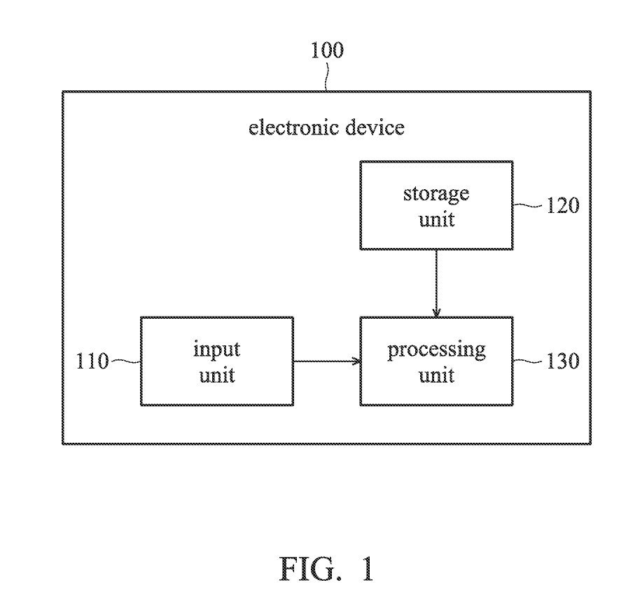

FIG. 1 is a block diagram of the electronic device in accordance with an embodiment of the invention. The electronic device 100 includes an input unit 110, a storage unit 120 and a processing unit 130. The electronic device 100 can be a personal digital assistant (PDA), a mobile phone, a smartphone, a notebook computer, a tablet, a game device, etc. The input unit 110 receives an input signal. The input unit 110 can be a touch-sensing unit. The input signal means a touch by a touching object corresponding to a Uniform Resource Identifier of a file resource detected by the touch-sensing unit. The touching object can be a finger, a stylus, or any object that can enable the touch-sensing electrodes. The Uniform Resource Identifier can be considered as a path for finding the file resource. For example, the Uniform Resource Identifier can be a character string for marking an Internet resource or an icon or a character string for executing a multimedia file. The storage unit 120 stores settings of a default application and a plurality of applications for executing the file resource. The processing unit 130 executes the file resource according to the input signal and the default application, and clears the setting corresponding to the default application.

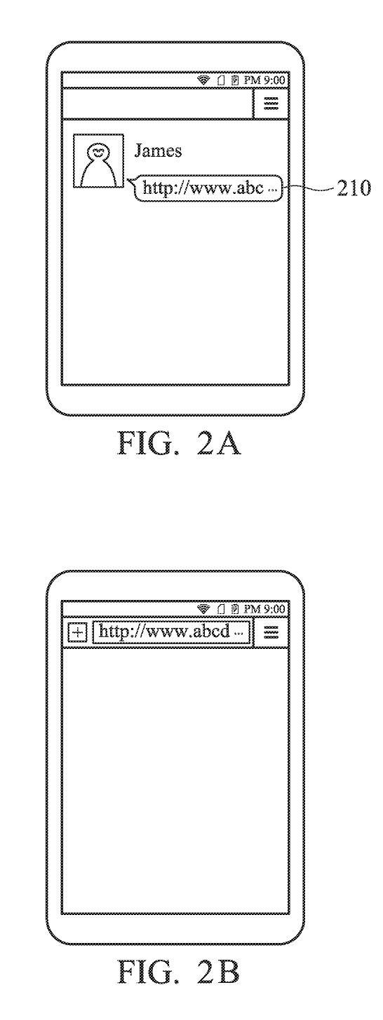

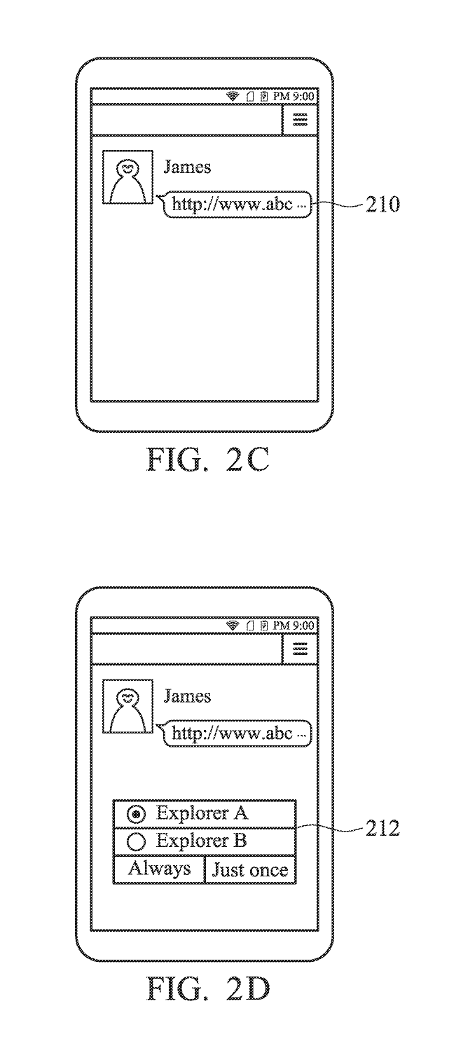

FIGS. 2A-2D are schematic diagrams for operating the user interface in accordance with an embodiment of the invention. As shown in FIG. 2A, the electronic device 100 displays a user interface 210 of a communication application. The user interface 210 has a window displaying a character string of the Internet resource. As shown in FIG. 2B, when the touching object touches the touch-sensing unit corresponding to the character string, the processing unit 130 opens the webpage according to which application has been set as the default application, such as Chrome Browser, stored in the storage unit 120 corresponding to the Internet resource according to the touch.

However, user can disable the default application within a first predetermined time after enabling the default application, and touch the character string once again within a second predetermined time when they want to reset the default or use another application for executing the Internet resource, and the processing unit 130 will clear the default stored in the storage unit 120. For example, as shown in FIG. 2C, when a user opens the webpage using the default application, disables the default application in 2 seconds, such as closes the application, switches the application by the recent key, or goes back to the main page of the user interface by the home key, and touches the character string displayed in a window 210 once again within 2 seconds, the processing unit 130 clears the default and displays the icons of the first browser (e.g. Chrome Browser) and the second browser (e.g. Firfox Browser) for the user (shown in FIG. 2D), and re-opens the webpage according to the user's selection. It should be noted that the settings of the first predetermined time and the second predetermined time are only the embodiments of the present invention, which is not limited thereto.

It should be noted that when the user does not disable the default application within the first predetermined time, such as 2 seconds, or touches the character string displayed in the window 210 once again within the second predetermined time, such as 2 seconds, after disabling the default application within the first predetermined time, the processing unit 130 will not clear the default, and will execute the file resource according to the default application as before.

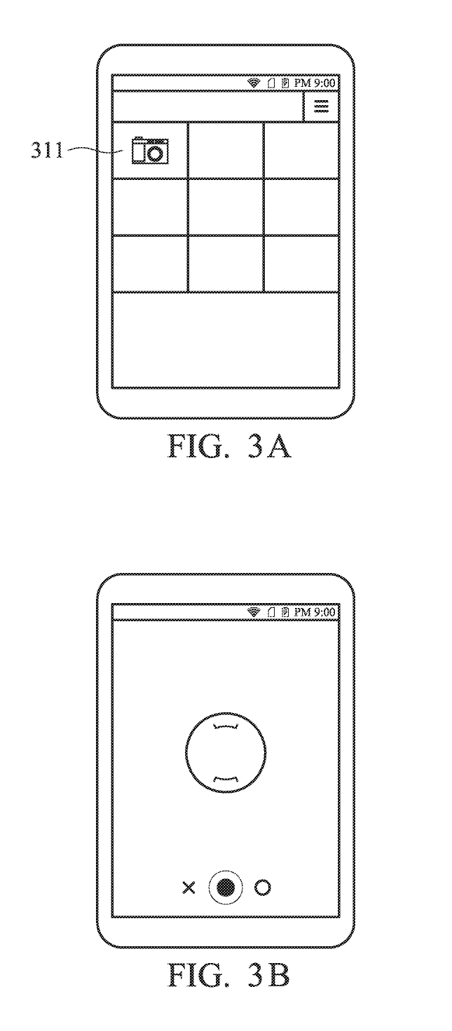

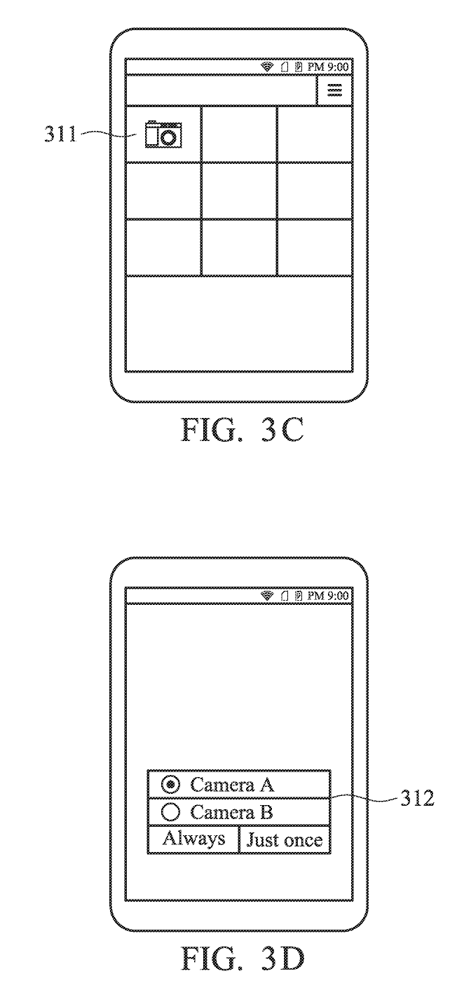

FIGS. 3A-3D are schematic diagrams for operating the user interface in accordance with another embodiment of the invention. As shown in FIG. 3A, the electronic device 100 displays a user interface 310 of a notebook application. When the user touches the icon (e.g. the icon 311 shown in FIG. 3A) for inserting an image, the processing unit 130 enables the predetermined camera application according to the default stored in the storage unit 120 (as shown in FIG. 3B). However, the user can disable the predetermined camera application in 2 seconds and touch the icon 311 once again in 2 seconds when the user wants to choose another camera application, the user interface 310 will clear the default and display a dialog 312 for displaying at least two icons or paths corresponding to different camera applications for the user (as shown in FIG. 3D), and the processing unit 130 will enable the camera application according to the choice made by the user.

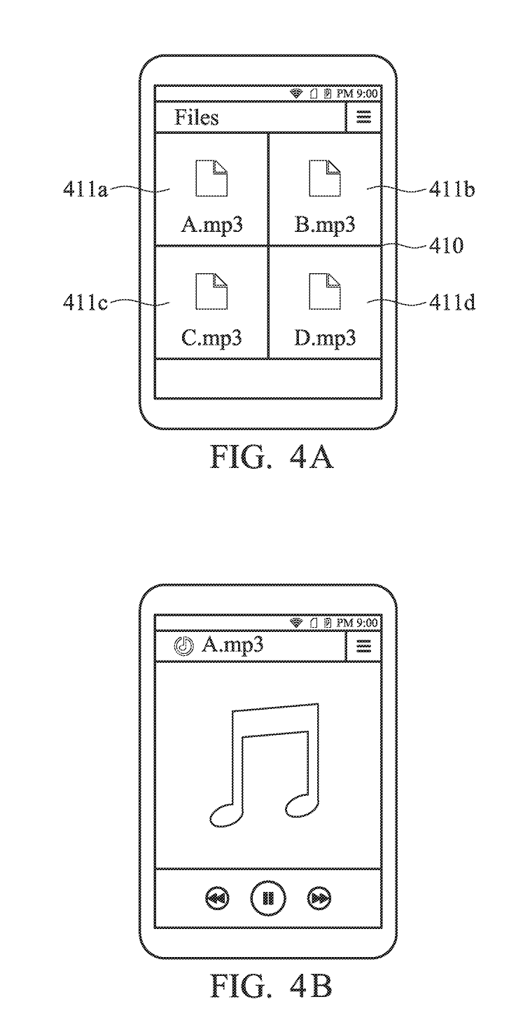

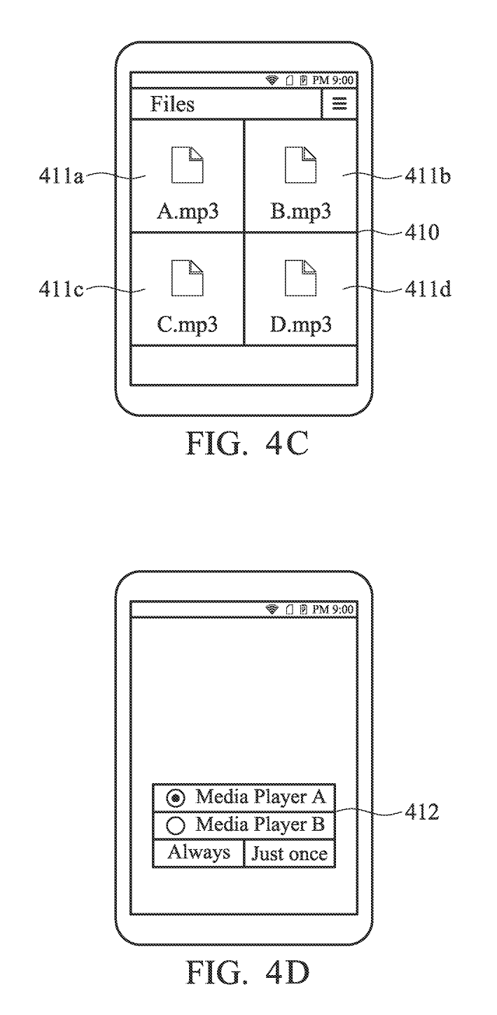

FIGS. 4A-4D are schematic diagrams for operating the user interface in accordance with another embodiment of the invention. As shown in FIG. 4A, the electronic device 100 displays the user interface 410 of a folder catalog. When the user selects and executes a plurality of multimedia files 411a-411d, the processing unit 130 executes a predetermined multimedia player for playing the multimedia files 411a-411d (as shown in FIG. 4B). However, the user can disable the predetermined multimedia player in 2 seconds (as shown in FIG. 4C) and select the multimedia files 411a-411d once again in 2 seconds when he wants to choose another multimedia player, and the user interface 410 will clear the default and display a dialog 412 for displaying at least two different multimedia players to the user (as shown in FIG. 4D). The processing unit 130 will enable the multimedia player once again according to the selection of the user.

According to another embodiment of the present invention, the file resource can be another type of file, such as a telephone number, a string of an address, or a profile. The processing unit 130 can execute the file resource through the default application by indentifying the string or determining the type of the profile.

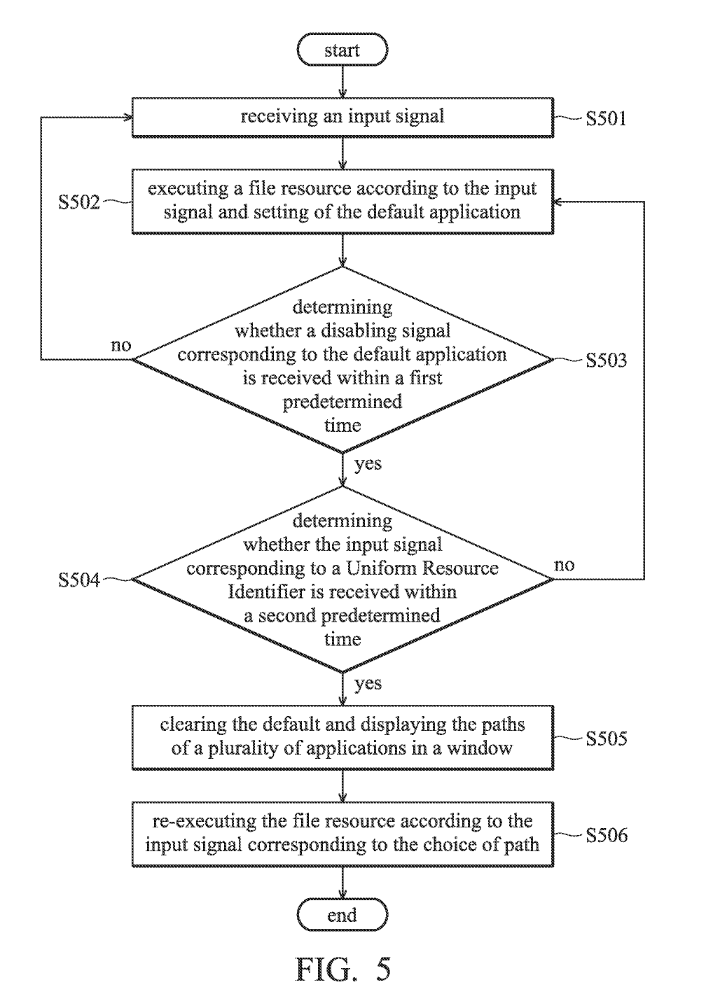

Please refer to FIG. 5 with FIG. 1. FIG. 5 is a flow chart of the method for operating the user interface in accordance with an embodiment of the invention. In step S501, the input unit 110 receives an input signal. The input unit 110 can be a touch-sensing unit. The input signal means a touch by a touching object corresponding to a Uniform Resource Identifier of a file resource detected by the touch-sensing signal. The touching object can be a finger, a stylus, or any object that can enable the touch-sensing electrodes. The Uniform Resource Identifier can be considered as a path for finding the file resource. In step S502, the processing unit 130 executes the file resource according to the input signal and the setting of the default application stored in the storage unit 120. In step S503, after enabling the default application, the processing unit 130 determines whether a disabling signal corresponding to the default application is received within a first predetermined time (e.g. 2 seconds). The disabling signal can be referred to the actions of closing the application, switching the application by the recent key, or going back to the main page of the user interface by the home key, etc. If the disabling signal is received within 2 seconds, the method proceeds to step S504, the processing unit 130 further determines whether the input signal corresponding to the Uniform Resource Identifier is received within a second predetermined time (e.g. 2 seconds). Otherwise, if the disabling signal is not received within 2 seconds, the method proceeds back to step S501, and the input unit 110 receives the input signal once again. In step S505, when the input unit 110 receives the input signal within the second predetermined time, the processing unit 130 clears the default and displays the paths of a plurality of applications in a window. In step S506, the processing unit 130 re-executes the file resource according to the input signal corresponding to the choice of path. It should be noted that, when the input unit 110 does not receive the input signal within the second predetermined time, the method proceeds back to step S502, the processing unit 130 executes the file resource by the default application.

As described above, an embodiment of the invention provides an electronic device, and a method for operating a user interface and a computer program product. When a user wants to choose another application for executing a file resource, he can disable the default application and enable the Uniform Resource Identifier once again in a predetermined time for clearing the default. In this way, complicated steps can be avoided and a better user experience can be provided.

The methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

It will be apparent to those skilled in the art that various modifications and variations can be made to the structure disclosed without departing from the scope or spirit of the invention. In view of the foregoing, it is intended that the present invention covers modifications and variations of this invention, provided they fall within the scope of the following claims and their equivalents.

What is claimed is:

1. An electronic device, comprising:
an input unit, configured to receive an input signal, wherein the input signal corresponds to a Uniform Resource Identifier of a file resource;
a storage unit, configured to store settings of a default application and a plurality of applications for executing the file resource; and
a processing unit, configured to execute the file resource according to the input signal and the default application, wherein after executing the file resource by the default application, the processing unit clears the setting of the default application and displays application shortcuts corresponding to the applications in a window when a disabling signal corresponding to the default application is received within a first predetermined time and the input signal corresponding to the Uniform Resource Identifier is received within a second predetermined time, and re-executes the file resource according to the input signal.

2. The electronic device as claimed in claim 1, wherein the Uniform Resource Identifier is a character string or an icon.

3. The electronic device as claimed in claim 1, wherein a type of the file resource is a webpage address, a multimedia file, an image, a telephone number or a profile.

4. The electronic device as claimed in claim 1, wherein the window is a dialog.

5. The electronic device as claimed in claim 1, wherein after the processing unit receives the disabling signal within the first predetermined time, but the input signal corresponding to the Uniform Resource Identifier is received without the second predetermined time, the processing unit maintains the setting of the default application and executes the file resource according to the default application.

6. A method for operating a user interface, adapted to an electronic device, comprising:
receiving an input signal, wherein the input signal corresponds to a Uniform Resource Identifier of a file resource;
executing the file resource according to the input signal and a default application;
determining whether a disabling signal corresponding to the default application is received within a first predetermined time;
determining whether the input signal corresponding to the Uniform Resource Identifier is received within a second predetermined time after receiving the disabling signal within the first predetermined time;
clearing a setting of the default application and displaying application shortcuts corresponding to a plurality of applications in a window after receiving the input signal within the second predetermined time; and
re-executing the file resource according to the input signal corresponding to the application.

7. The method as claimed in claim 6, wherein the Uniform Resource Identifier is a character string or an icon.

8. The method as claimed in claim 6, wherein a type of the file resource is a webpage address, a multimedia file, an image, a telephone number or a profile.

9. The method as claimed in claim 6, wherein the window is a dialog.

10. The method as claimed in claim 6, the steps further comprising:
after receiving the disabling signal within the first predetermined time, when the input signal corresponding to the Uniform Resource Identifier is received without the second predetermined time, maintaining the setting of the default application, and executing the file resource according to the default application.

11. A computer program product encoded in at least one non-transitory computer usable medium for use with a computing device, wherein the computer device comprises a storage unit, configured to store settings of a default application and a plurality of applications for executing the file resource, the computer program product comprising:
computer readable program code embodied in said medium, for specifying a microprocessor, the computer readable program code comprising:
first program code for receiving an input signal by an electronic device, wherein the input signal corresponds to a Uniform Resource Identifier of a file resource;
second program code for executing the file resource according to the input signal and a default application;
third program code for determining whether a disabling signal corresponding to the default application is received within a first predetermined time;
fourth program code for determining whether the input signal corresponding to the Uniform Resource Identifier is received within a second predetermined time after receiving the disabling signal within the first predetermined time;
fifth program code for clearing a setting of the default application and displaying application shortcuts corresponding to a plurality of applications in a window after receiving the input signal within the second predetermined time; and
sixth program code for re-executing the file resource according to the input signal corresponding to the application.
